(19) United States
(12) Patent Application Publication
(10) Pub. No.: US 2003/0201680 A1
(43) Pub. Date: Oct. 30, 2003

(54) Singular bearing mechanism of stepper motor

(75) Inventor: Chia-Wei Lin, Taichung (TW)

Correspondence Address: BROWDY AND NEIMARK, P.L.L.C., 624 NINTH STREET, NW, SUITE 300, WASHINGTON, DC, 20001-5303, US

(73) Assignee: NEOCENE TECHNOLOGY CO., LTD., Taichung (TW)

(21) Appl. No.: 10/419,924

(22) Filed: Apr. 22, 2003

(30) Foreign Application Priority Data
Apr. 25, 2002 (TW) 91205713

(51) Int. Cl. H02K 37/00; H02K 5/16; H02K 7/08; H02K 5/00

(52) U.S. Cl. 310/49 R; 310/257; 310/90; 310/91

(57) ABSTRACT

A stepper motor with bearing mechanism comprised by a sole-singular bearing element is developed. The sole-singular bearing element is mounted and fixed at a hole of the motor frame-cup and/or motor-mount-plate for the fixation. The bearing element is with elongated length extended inward to the internal space within the inner part of the rotor of the stepper motor.

### BACKGROUND OF THE INVENTION

1. Field of the Invention

The present invention relates generally to a structure of a motor, and more particularly to a sole-singular bearing mechanism of a stepper motor.

2. Description of the Related Art

FIG. 1 shows a conventional stepper motor 5 having a casing 10, a stator 11 mounted in the casing 10, a induced magnetic field chamber 12 at the center of the stator 11, and a plurality of coil-windings (not shown) around the stator 11. The winded coils generate induced variable magnetic field in the chamber 12 while electric-current is applied to the coil terminals. A rotor 13 is installed in the chamber 12 such that the rotor 13 will be driven to rotate by the interactions between the induced magnetic field and the polarized permanent magnetic field with the rotor. Conventionally, the casing 10 is provided with two separate bearings, the front-bearing 14 and the end-bearing 15, at a top and a bottom position of the casing respectively thereof. The two bearings 14 and 15 are conventionally with short length. The rotor 13 is fixed with a shaft 16 at a center thereof and the shaft 16 is coupled with the front-bearings 14 and the end-bearing 15 to make the rotor 13 and the shaft 16 rotate stably.

The shaft 16 has a central axis 161 which an orientation is decided and limited by the positioning and central-alignment of the front and end bearings 14 and 15. It is obvious that under the situation with poorly alignment of the centering of the front-bearing 14 and the end-bearing 15 will make the axis 161 of the shaft 16 deflected, as shown in FIG. 1. And, the shaft run-out behavior of the stepper motor is inevitably influenced. The conventional stepper motors are currently used in various precision instruments, such as CD-ROM driver, scanner, printer, and multi-function-peripherals. The deflection of the central axis of the shaft of the stepper motor will make the shaft run-out go badly; and the application instrument will be unable to achieve the precise performance, such as the read/write performance of a CD-ROM driver and image resolution of a scanner. Even more seriously, the central axis deflection by the misalignment of the front-bearing 14 and the end-bearing 15 may cause the stepper motor of shaft jam-lock or even dead-lock, as the motor will be totally damaged and useless.

### SUMMARY OF THE INVENTION

The primary objective of the present invention is to provide a bearing mechanism of a stepper motor, comprised by a sole-singular bearing element, in which the shaft central axis deflection and shaft run-out characteristics are dramatically improved.

According to the objectives of the present invention, a stepper motor with bearing mechanism comprised by a sole-singular bearing element is developed. The sole-singular bearing element is mounted and fixed at a hole of the motor frame-cup and/or motor-mount-plate for the fixation. The bearing element is with elongated length extended inward to the internal space within the inner part of the rotor of the stepper motor. A stepper motor of the present invention includes a casing frame-cup having a chamber therein and a hole at a side thereof, a stator installed in the chamber of the frame-cup having a magnetic field chamber at a center thereof and a plurality of coil-windings to generate induced variable magnetic field in the magnetic field chamber, a rotor installed in the magnetic field chamber of the stator, and the sole-singular bearing element fixed in the motor frame-cup and/or motor-mount-plate. A shaft running through and wherein an inner end of the shaft is fixed with the rotor. The shaft is then running through the sole-singular bearing, and an outer end thereof is extended out of the frame-cup such that the rotor rotates along an axis orientation of the shaft directed by the sole-singular bearing.

### BRIEF DESCRIPTION OF THE DRAWINGS

FIG. 1 is a sectional view of a conventional stepper motor;

FIG. 2 is a sectional view of a first preferred embodiment of the present invention, and

FIG. 3 is a sectional view of a second preferred embodiment of the present invention, and

FIG. 4 is a sectional view of a third preferred embodiment of the present invention.

### DETAILED DESCRIPTION OF THE INVENTION

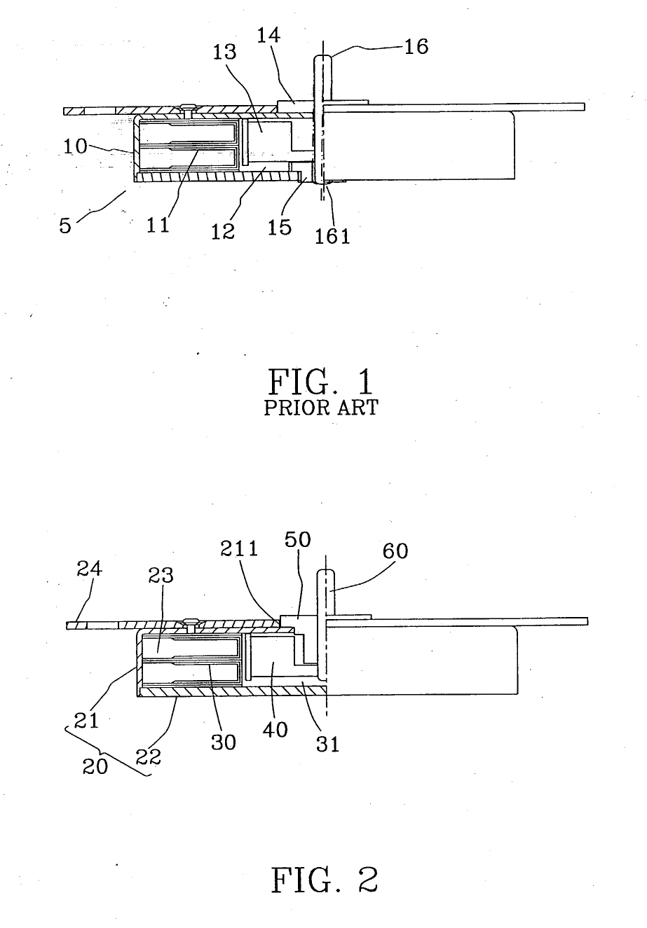

Please refer to FIG. 2, a stepper motor of the first preferred embodiment of the present invention mainly consists of a casing 20, a stator 30, a rotor 40 and a sole-singular bearing 50, wherein:

The casing 20 is composed mainly of a frame-cup 21 and a back-plate 22 coupled with each other to form a chamber 23 therein. The frame-cup 21 is fixed with a motor-mount-plate 24 at a top thereof, which the stepper motor is secured on an application instrument via the motor-mount-plate 24.

The stator 30 is installed in the chamber 23 of the casing 20 at a center of which has a magnetic field chamber 31. Plural coil windings (not shown) are winded around the bobbin groove of the stator 30. The coil windings generate induced variable magnetic field in the magnetic field chamber 31 while electric-current is applied to the coil terminals.

The rotator 40 is a magnetic block installed in the magnetic field chamber 31 of the stator 30. The rotator 40 can be driven to rotate by the magnetic interactions between the induced magnetic field and the polarized permanent magnetic field with the rotor.

The main character of the present invention is that the casing 20 only possesses a sole-singular bearing 50 at a side thereof. In the first embodiment, the bearing 50 is fixed in a hole 211 at a center of the frame-cup 21 with a bottom elongated section thereof extended inward to the chamber 23 of the casing 20. A shaft 60 runs through the bearing 50 and has an inner end fixed to the rotator 40 and a front end extended out of the casing 20.

Because the sole-singular bearing 50 leaves a bottom elongated section thereof in the chamber 23 of the casing 20 and the shaft 60 is engaged with the sole-singular bearing 50 at a mid section thereof, an central axis orientation of the shaft 60 is exactly as same as a center orientation of the sole-singular bearing 50; and the shaft 60 will not be deflected like the conventional two bearings misalignment situation does. The rotator 40 can rotate stably along the axis of the shaft 60 and drives the shaft 60 rotating therewith. Run-out characteristics of the stepper motor of the present invention thus are greatly enhanced; while the jam-lock and dead-lock phenomena have also been improved.

To compare with the conventional stepper motor having two bearings and potential misalignment issues, the stepper motor of the present invention contains only a sole-singular bearing, thus has an advantage of the devoid of the precise alignment problem of aiming in two bearings condition. The central axis of the shaft will always keep straight, while the run-out and jam-lock, dead-lock characteristics are greatly improved.

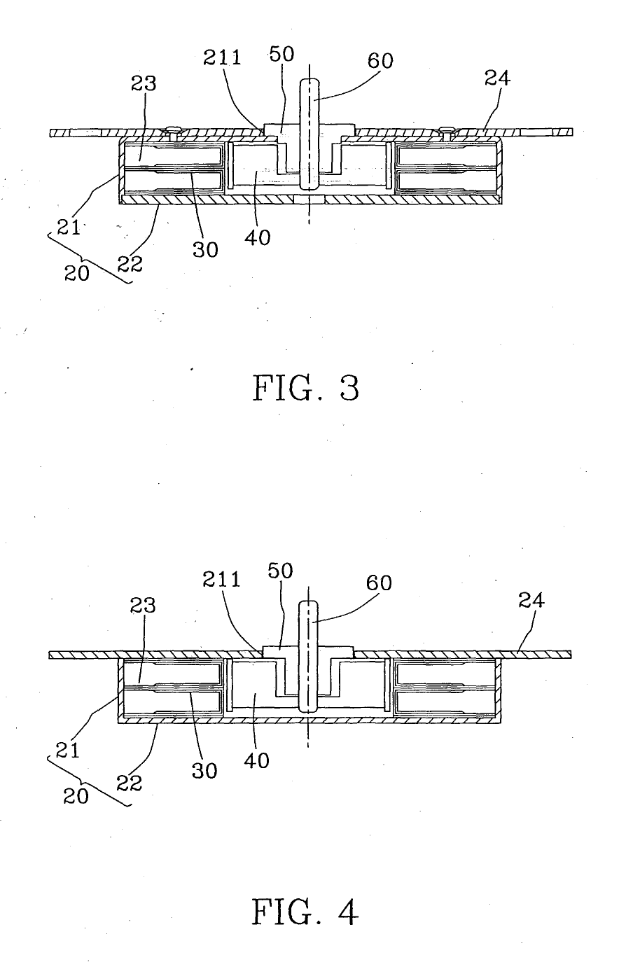

FIG. 3 shows a stepper motor of the second preferred embodiment of the present invention, in which a small central hole is provided at a back plate of a casing. However, the central hole at the back plate is simply for assembly facilitating, while no bearing is provided thereon in the hole.

FIG. 4 shows a stepper motor of the third preferred embodiment of the present invention, in which the frame-cup is directly coupled with the motor-mount-plate to form the casing. There is no back plate used in embodiment in this case. The sole-singular bearing is fixed in a central hole of the motor-mount-plate; while the central hole of the frame-cup is still kept, but without a bearing installed thereon.

What is claimed is:

1. A stepper motor, comprising:
a casing having a chamber therein and a hole at a side thereof;
a stator installed in the chamber of the casing having a magnetic field chamber at a center thereof and a plurality of coil windings to generate induced variable magnetic field in the magnetic field chamber while electric-current is applied to the coils;
a rotor installed in the magnetic field chamber of the stator to be driven to rotate by magnetic interactions between the induced magnetic field and the polarized permanent magnetic field with the rotor;
a sole-singular bearing fixed in the hole of the casing, with a bottom elongated section thereof extended inward to the chamber of the casing; and,
a shaft running through the bearing and has an inner end fixed to the rotator 40 and a front end extended out of the casing such that the rotor rotates along an axis orientation of the shaft conducted by the sole-singular bearing and the shaft is driven to rotate by the rotator.

2. The stepper motor as defined in claim 1, wherein the casing has a frame-cup and a back-plate coupled with each other.

3. The stepper motor as defined in claim 2, wherein the hole is provided at the frame-cup and the sole-singular bearing is fixed in the frame-cup hole.

4. The stepper motor as defined in claim 3, wherein the frame-cup is fixed with a motor-mount-plate to secure the stepper motor on an application instrument.

5. The stepper motor as defined in claim 2, wherein the frame-cup is fixed with a motor-mount-plate and both of the frame-cup and the motor-mount plate respectively have a hole, while the sole-singular bearing is fixed in the hole on the motor-mount plate therein.

6. The stepper motor as defined in claim 2, wherein the frame-cup is fixed with a motor-mount-plate and both of the frame-cup and the motor-mount plate respectively have a hole to fix the sole-singular bearing therein.

7. The stepper motor as defined in claim 3, wherein the back-plate has a central hole for assembly facilitating, while no bearing is provided on the back-plate thereon.

8. The stepper motor as defined in claim 5, wherein the back-plate has a central hole for assembly facilitating, while no bearing is provided on the back-plate thereon.

9. The stepper motor as defined in claim 6, wherein the back-plate has a central hole for assembly facilitating.

10. The stepper motor as defined in claim 1, wherein the casing is composed by a frame-cup directly closed-fixed to a motor-mount plate, and the sole-singular bearing is fixed in the hole on the frame-cup therein.

11. The stepper motor as defined in claim 1, wherein the casing is composed by a frame-cup directly closed-fixed to a motor-mount plate, and the sole-singular bearing is fixed in the hole on the motor-mount plate therein.
